(19) United States
(12) Patent Application Publication
(10) Pub. No.: US 2020/0147556 A1
(43) Pub. Date: May 14, 2020

(54) SYSTEM AND METHOD FOR CLEANING MEMBRANE FILTERS IN-LINE IN A WATER PURIFICATION SYSTEM

(71) Applicant: Lonza Ltd., Visp (CH)

(72) Inventor: Michael Mietzner, Fremont, NH (US)

(21) Appl. No.: 16/677,786

(22) Filed: Nov. 8, 2019

Related U.S. Application Data
(60) Provisional application No. 62/758,001, filed on Nov. 9, 2018.

(51) Int. Cl. B01D 65/02; C02F 1/44; C02F 1/78; B01D 61/02; B01D 61/08; B01D 71/02; B01D 69/02

(52) U.S. Cl. CPC B01D 65/02; B01D 2321/168; C02F 1/78; B01D 61/025; B01D 61/08; B01D 71/02; B01D 69/02; C02F 2303/16; C02F 2201/782; B01D 2325/02; B01D 2311/2634; B01D 2313/243; B01D 2317/025; B01D 2317/04; B01D 2321/04; C02F 1/441

(57) ABSTRACT

A process and system for cleaning semipermeable membranes is described that is particularly well suited for cleaning membranes contained in a water purification system, such as a reverse osmosis process. In order to clean the filter membranes, the membranes are placed in a cleaning chamber capable of allowing a reduction in pressure. In one embodiment, for instance, the membranes are contained in a filter housing and the filter housing is converted into a cleaning chamber by sealing off at least one end. The membranes are then submerged in a cleaning fluid and the pressure within the cleaning chamber is reduced causing the cleaning fluid to form bubbles. The process and system of the present disclosure is well suited to cleaning filter membranes, particularly ceramic membranes, in-line without having to remove the membranes from the water purification system.

### RELATED APPLICATIONS

The present application is based on and claims priority to U.S. Provisional Patent application Ser. No. 62/758,001, filed on Nov. 9, 2018, which is incorporated herein by reference.

### BACKGROUND

Reverse osmosis is a water purification technique commonly used in the desalination of salt water. Reverse osmosis can also be used in many other industries and for various different purposes. For instance, other applications of reverse osmosis include wastewater treatment, feed processing, pharmaceutical processing, minerals processing, beverage processing, biotechnology processing, and for pure water production. In general, during reverse osmosis, a feedwater is forced through a semipermeable membrane at a pressure greater than the osmotic pressure of the water. Under pressure, purified water passes through the membrane while salts and other dissolved ions and molecules are retained. The permeate which represents the purified water is discharged through a permeate outlet. A reject water stream that does not pass through the membrane is also created.

One consistent problem faced by those skilled in the art in reverse osmosis processes and other water purifying processes is the eventual fouling of the membrane filter elements. Fouling rates of membranes is very unpredictable. Fouling rates, for instance, can be influenced by the solutes present, their concentration, membrane type, and pore size distribution. Membrane fouling can greatly increase the expense of the reverse osmosis process. For instance, fouled membranes can greatly increase the amount of reject water that is produced. Cleaning and replacing filter membranes also represents significant downtime of the process. For instance, the cost of operating the process increases in terms of both the replacement cost of the membrane filters and the cost associated with downtime of the system. Thus, operators of reverse osmosis processes are typically faced with the decision of running the system at a lower reject water rate and replacing the filters more often or running the system at a higher reject water rate and replacing the filters less often.

In the past, once filter membranes became fouled, the membranes where either completely replaced or cleaned. In order to clean the membranes, the membranes were removed from the system and cleaned by using different chemical solutions to dissolve deposits formed on the membrane surface. Some of these chemical solutions are environmentally regulated and thus must be disposed of in a carefully controlled fashion.

In view of the above, a need exist for a method and process for cleaning filter membranes in water purifying systems, such as reverse osmosis systems.

### SUMMARY

In general, the present disclosure is directed to an in-line method and system for cleaning filter membranes in water purification systems. The water purification system, for instance, can be used to generate purified water and water for injection for a variety of fields. For example, in one embodiment, the system and method of the present disclosure can use reverse osmosis for producing purified water for the pharmaceutical industry and/or biotechnology industry. In one embodiment, for instance, the purified water can be used in producing cell cultures, such as during the manufacture of mammalian cell lines.

In general, the method of the present disclosure is directed to cleaning membrane filters in-lines without removing the filters from the water purification process. The membrane filters are cleaned by subjecting the filters to a cleaning liquid at a reduced pressure, below the vapor pressure of the cleaning liquid. A vacuum pump, for instance, can be used to evacuate gases thereby forming a vacuum that causes a cleaning liquid to bubble on the membrane. The action of bubble formation removes any contaminated matter that can cause fouling. The present disclosure is particularly directed to cleaning ceramic filters capable of withstanding the cleaning environment.

For example, in one embodiment, the present disclosure is directed to a method for purifying water. The method includes forcing a flow of water through at least one filter bank to form a purified water stream and a reject water stream. The filter bank comprises at least one membrane constructed to withstand vacuum-like conditions, such as a ceramic membrane. In accordance with the present disclosure, the ceramic membrane is periodically cleaned in-line. The ceramic membrane is cleaned by subjecting the ceramic membrane to a liquid in an atmosphere that is below the vapor pressure of the liquid. For example, in one embodiment, the ceramic membrane can be contained within a separate filter housing. The filter housing can be converted into a cleaning chamber by sealing off one side of the housing. During cleaning, cleaning fluid can be fed to the filter housing such that the ceramic membrane is submerged in the liquid. As the ceramic membrane is being submerged in the liquid, the pressure in the filter housing can be lowered below the vapor pressure of the liquid by evacuating gases from the housing. As the pressure is lowered, the surface of the ceramic membrane creates nucleation sites for bubble formation of the liquid. The rapid bubbling of the liquid cleans the membrane. If desired, the pressure can then be increased above the vapor pressure of the liquid and the membrane can be rinsed. The cleaning liquid can comprise water or water in combination with a non-aqueous solvent. In one embodiment, the ceramic membrane can be exposed to multiple cycles during cleaning by repeatedly being subjected to the liquid below the vapor pressure followed by rinsing with the liquid at a pressure above the vapor pressure.

In one embodiment, the process can further include the step of ozonating a feedwater source to produce the flow of water that is forced through the filter bank. The ozonated water can include a total organic carbon content. The ceramic filter can further lower the total organic carbon content of the water.

The present disclosure is also directed to a reverse osmosis system. The system includes at least one filter bank comprising at least one ceramic membrane contained in a filter housing. A pump is used for forcing a flow of water through the filter bank in order to produce a purified water stream and a reject water stream. In accordance with the present disclosure, the system further includes a cleaning subsystem for periodically cleaning the ceramic membrane in-line. As used herein, the term “in-line” means the ceramic membrane is cleaned without having to remove the ceramic membrane from its filter housing. The cleaning subsystem includes a capping device for converting the filter housing into a cleaning chamber and a vacuum pump for evacuating gases from the cleaning chamber. The cleaning subsystem further includes a cleaning fluid source that feeds a cleaning fluid into the cleaning chamber. The cleaning subsystem is configured to periodically clean the ceramic membrane by converting the filter housing into a cleaning chamber, flowing a cleaning fluid into the cleaning chamber, and evacuating gases from the chamber using the vacuum pump until the atmosphere in the cleaning chamber is below the vapor pressure of the cleaning liquid.

In one embodiment, the system can include multiple filter banks positioned in series. Each filter bank can be associated with a cleaning subsystem. In one embodiment, the system includes one vacuum pump in communication with expansion space that can be diverted to each filter bank housing using appropriate valving. The expansion space, which may be provided by an expansion device, is for allowing volume increase during gas expansion. In one embodiment, the expansion space is positioned higher than each of the filter housings. After a cleaning, the filter housing is flushed and returned to service. The filter housings can be cleaned cyclically as needed based on various factors, such as based on a percent increase in the volume of the reverse osmosis reject stream, based upon differential pressure spikes, or based upon other factors.

The ceramic membrane can generally have an average pore size of less than 1 nm. In one embodiment, the ceramic membrane can be DNA templated. As described above, the ceramic membrane is contained in a filter housing. In one embodiment, multiple ceramic membranes are contained in a single filter housing. The capping device associated with the filter housing can comprise a valve that closes off one end of the filter housing.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a diagram illustrating one embodiment of a water purifying system that may be used in accordance with the present disclosure;

FIG. 2 is a diagrammatical view of one embodiment of the filter cleaning system of the present disclosure;

FIG. 3 is a cross-sectional view of one embodiment of a semipermeable membrane comprised of filter elements contained in a housing that may be cleaned in accordance with the present disclosure; and

FIG. 4 is a diagram illustrating another embodiment of a water purification system made in accordance with the present disclosure that includes multiple filter banks positioned in series.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a cleaning system for cleaning filter membranes and to a process for cleaning filter membranes. The filter membranes, for instance, can be a component of a water purification system. For example, in one embodiment, the filter membranes may be incorporated into a reverse osmosis water purification system. Reverse osmosis, for instance, is used to produce purified water, such as water for injection. Water for injection generally must be of extra high quality and must be substantially free of contaminants. Water for injection, for instance, can be used in medical applications, in pharmaceutical applications, and in other biotechnology processes. For example, water for injection is commonly used in cell culture processes, such as processes for producing mammalian cells. Reverse osmosis is used to produce water for injection by pumping water through membranes to form a purified water stream and a reject water stream. The cost of operating a reverse osmosis system is generally driven by the amount of reject water that is produced. Lower amounts of reject water, for instance, makes the system much more economical.

In general, the amount of reject water that is produced during reverse osmosis can depend upon the ability of the membranes to function efficiently. The membrane filters, however, typically become fouled during use. Once fouling has occurred on the membrane filters, in the past, the filter membranes were either completely replaced or removed from the system, cleaned and replaced back in the system. Either technique requires that the system be taken off-line which lowers throughput and further increases the cost of running the process. In this regard, the present disclosure is generally directed to a cleaning system and process for cleaning membrane filters in-line without having to remove the filter membranes from the system.

In accordance with the present disclosure, in order to clean the filter membranes, the filter membranes are contacted with a cleaning liquid at reduced pressure, such as at a pressure below the vapor pressure of the cleaning liquid. In this manner, the cleaning liquid forms bubbles on the surface of the membrane. In other words, the membrane creates nucleation sites for bubble formation of the liquid when the pressure is lowered. The formation of bubbles is similar to small, tiny explosions occurring at the membrane surface which dislodges contaminants and cleans the membrane.

The membrane filters used in accordance with the present disclosure are selected such that they can withstand a lower pressure environment without degrading or imploding. Thus, in one embodiment, the membrane filters used in accordance with the present disclosure are ceramic membranes that are more durable than various other membranes. Alternatively, the process can be operated such that both sides of the membrane surface are subject to equal vacuum-like forces that prevent damage to the membrane during the cleaning process. For example, in one embodiment, the membrane filters can be cleaned without creating a pressure differential on each side of the membrane.

The process and system of the present disclosure produces numerous advantages and benefits. For instance, as described above, in one embodiment, the filter membranes can be cleaned in-line without having to remove the membranes from the water purification system. For instance, the filter membranes can be located within a filter housing. The filter housing can be converted into a cleaning chamber capable of allowing the evacuation of gasses for producing a low pressure atmosphere or environment that surrounds the membrane.

In addition to being capable of cleaning filter membranes in-line, the process and system of the present disclosure does not require the use of organic cleaning solvents in that water can serve as the cleaning fluid. For example, in one embodiment, the cleaning fluid can comprise water, such as water heated to a temperature of from about 40° C. to about 90° C., such as from about 60° C. to about 80° C. In an alternative embodiment, however, the aqueous cleaning solution may contain a non-aqueous cleaning chemical.

Another advantage to the process and system of the present disclosure is that the filter membranes can be cleaned without having to replace the membranes.

Another advantage to the system and process of the present disclosure is that the filter membranes can be cleaned without having to shut down the water purification process. For example, in one embodiment, the water purification system can include a plurality of filter membranes. One or more of the filter membranes can be subjected to a cleaning process while the remaining filter membranes may remain in operation.

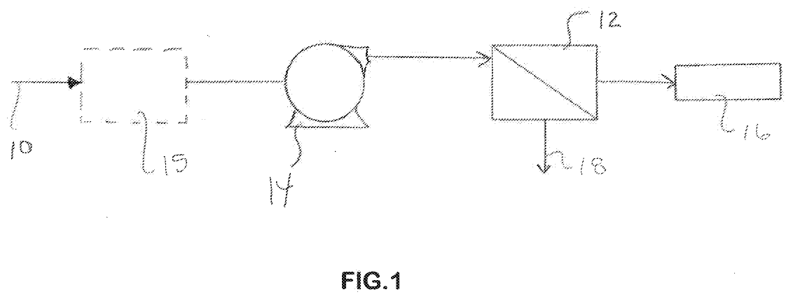

Referring to FIG. 1, one embodiment of a water purification system that may incorporate the cleaning system and process of the present disclosure is shown. For example, in one embodiment, the water purification system illustrated in FIG. 1 may comprise a reverse osmosis system. As shown, the system includes a water supply 10 that is pumped or forced through a semipermeable membrane 12 by a pump 14. The water supply 10, for instance, can be forced through the semipermeable membrane 12 at a pressure greater than the osmotic pressure of the water. Under pressure, purified water passes through the semipermeable membrane 12 while salts and other dissolved ions and molecules are retained. As shown in FIG. 1, the process produces a purified water stream 16, also known as a permeate outlet. A reject water stream 18 that does not pass through the membrane is also created.

In one embodiment, the water purification system can include an ozonator 15. The ozonator 15, for instance, can be configured to inject ozone into the feed water stream 10. Ozone is an oxidant and capable of oxidizing many contaminants that may be contained within the feed water supply, such as molecules containing carbon to carbon double bond. Ozone can also oxidize aromatic compounds, such as aromatic alcohols.

Ozonation reactions in aqueous solutions involve either direct reactions with molecular ozone or indirect reactions with hydroxyl radicals. For example the decomposition reactions that occur can be catalyzed by hydroxide ions and other dissolved compounds.

The reaction of organic compounds with ozone or hydroxyl radicals will produce organic free radicals that ultimately result in the formation of aldehydes, ketones, alcohols, and carboxylic acids. In general, during ozonation, larger molecules are cleaved. This cleavage results in lower molecular weight material and the formation of more polar and hydrophilic compounds.

Ozone not only breaks down contaminants that may be contained in the feed water supply 10, but ozone can also reduce fouling of the semipermeable membrane 12.

The efficiency of the water purification system as shown in FIG. 1 is directly proportional to the amount of purified water 16 produced in relation to the volume of reject water 18 that is produced. During operation, the semipermeable membrane 12 can become fouled after repeated use. Fouling of the semipermeable membrane 12 can cause many problems in operating the system. Perhaps most importantly, fouling of the membrane 12 can lead to greater amounts of rejected water. In this regard, the system and process of the present disclosure is directed to periodically cleaning the semipermeable membrane 12 so as to maintain a highly efficient process that minimizes the amount of reject water 18 that is produced. Of particular advantage, as will be described in greater detail below, the process and system of the present disclosure is capable of cleaning semipermeable membranes in-line so that the membranes do not need to be removed from the water purification system. The capability of cleaning the semipermeable membrane 12 in-line can dramatically improve the process economics by minimizing the amount of downtime needed to ensure that the membrane 12 is operating properly and efficiently.

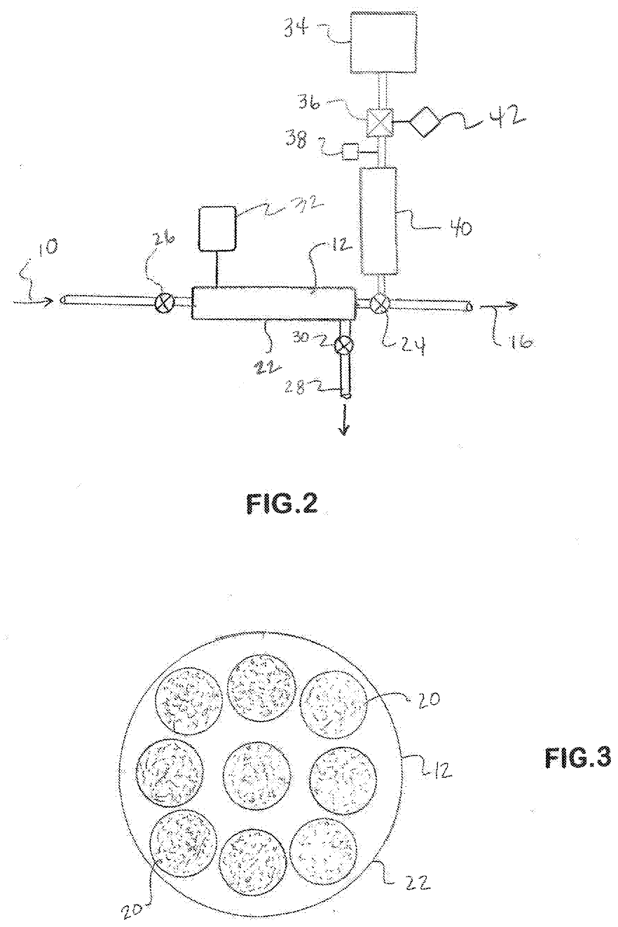

Referring to FIG. 2, for instance, one embodiment of a process and system for cleaning semipermeable membranes in accordance with the present disclosure is shown.

In order to clean the semipermeable membrane 12 in accordance with the present disclosure, a cleaning chamber capable of being pressurized is formed around the membrane. The membrane is then submerged in a cleaning liquid by feeding a cleaning liquid into the cleaning chamber. The pressure within the cleaning chamber is then reduced below the vapor pressure of the cleaning liquid. Reducing the pressure causes the cleaning liquid to bubble and create vapor. Unsmooth portions on the surface of the membrane 12 create nucleation sites for bubble formation. The bubble formation on the membrane creates tiny explosions that dislodge and remove any contaminants that cause fouling.

Once the semipermeable membrane 12 is exposed to the cleaning liquid at a reduced pressure, the pressure is then increased to, for instance, atmospheric pressure. The cleaning liquid can then be agitated in order to rinse the semipermeable membrane 12. Thus, in one embodiment, the cleaning process includes two phases. During the first phase, the semipermeable membrane 12 is exposed to the cleaning liquid at reduced pressure that causes the cleaning liquid to form bubbles on the surface of the membrane. This first phase is then followed by a second phase where the cleaning liquid is agitated around the membrane at standard pressures in order to rinse the membrane. In one embodiment, the semipermeable membrane 12 can be exposed to multiple cycles that alternate between the first phase and second phase. For instance, in one embodiment, the semipermeable membrane 12 can be exposed to from about 1 to about 20 cleaning cycles, such as from about 2 to about 15 cleaning cycles, such as from about 3 to about 10 cleaning cycles. After each cleaning cycle or after the entire cleaning process, the cleaning liquid can be drained and the semipermeable membrane 12 can be placed back into operation.

As shown in FIG. 3, in one embodiment, the semipermeable membrane 12 can comprise multiple filter elements 20 contained in a filter housing 22. During operation of the water purification system, water is forced through the filter elements 20 that are contained in the filter housing 22.

In one embodiment of the present disclosure, the filter housing 22 can be converted into a cleaning chamber in order to clean the filter elements 20. For example, as shown in FIG. 2, filter housing 22 is in communication with a feed water supply 10. As described above, the feed water supply 10 is forced through the semipermeable membrane 12 to form a purified water stream 16. In one embodiment, a first flow control device 24, such as a valve, can be placed on the effluent of the filter housing 22. In addition, a second or upstream flow control device 26 can be place on the influent of the filter housing 22. The filter housing 22 can also be in communication with a drain line 28. A flow control device 30 can be placed on the drain line 28 for starting and stopping flow from the filter housing 22 into the drain line 28.

Closing off fluid flow using the flow control devices 24, 26 and 30 can convert the filter housing 22 into a cleaning chamber capable of being pressurized. In addition to using flow control devices as shown in FIG. 2, various other capping devices may be used in order to convert the filter housing 22 into a cleaning chamber capable of being pressurized. For example, in other embodiments, the purified water stream or influent 16 can be disconnected from the filter housing and a lid can be installed on the end of the filter housing 22. The lid can be sealed to the filter housing 22 for forming a cleaning chamber being capable of being pressurized.

Once the filter housing 22 is formed into a cleaning chamber, the filter housing 22 is filled with a cleaning fluid such that the semipermeable membrane 12 becomes submerged within the cleaning fluid. In one embodiment, the cleaning fluid or liquid may be water. In fact, in one embodiment, the feed water may be used as a cleaning liquid. In other embodiments, another water source may be used as a cleaning liquid or, alternatively, the purified water stream 16 may be redirected back into the filter housing to serve as the cleaning liquid.

In one embodiment, the cleaning liquid may contain a non-aqueous solvent. The non-aqueous solvent may be used alone or in combination with water. For instance, as shown in FIG. 2, the system can include a chemical solvent supply 32. Various different non-aqueous chemicals may be fed to the filter housing 22 depending upon the particular application and the type of contaminants to be removed from the semipermeable membrane 12. Non-aqueous chemicals that may be used in accordance with the present disclosure include, for instance, acids, bases, and the like. Acids include, for instance, acidic acid, citric acid, boric acid, mixtures thereof, and the like. In one embodiment, the cleaning liquid can include an amine. Amines include ethanolamine, ethyldiamine, diethanolamine, and mixtures thereof. Other non-aqueous chemicals that may be used include acetone and methylethylketone. In one particular embodiment, the non-aqueous chemical may comprise an oxidizing agent. For instance, the non-aqueous chemical may comprise a hydroxide. Hydroxides that may be used include sodium hydroxide, potassium hydroxide, ammonium hydroxide, mixtures thereof, and the like. Other oxidizing agents include peroxides such as hydrogen peroxide, benzoyl peroxide, and mixtures thereof.

The temperature of the cleaning liquid can be varied depending upon the particular application. For example, in one embodiment, the cleaning liquid can be at ambient temperature, such as at a temperature of from about 20° C. to about 25° C. In an alternative embodiment, however, the cleaning liquid can be heated. A heated cleaning liquid may not only remove fouling elements from the membrane but may facilitate expansion and contraction. For instance, the cleaning liquid can be heated to a temperature of greater than about 30° C., such as greater than about 35° C., such as greater than about 40° C., such as greater than about 45° C., such as greater than about 50° C., such as greater than about 55° C., such as greater than about 60° C., such as greater than about 65° C., such as greater than about 70° C., and generally less than about 95° C., such as less than about 90° C., such as less than about 85° C., such as less than about 80° C.

Once the cleaning liquid is charged to the filter housing 22, the filter housing 22 can be completely sealed by closing off any further flow control devices, such as flow control device 26. The pressure within the filter housing 22 is then reduced below the vapor pressure of the cleaning liquid. In one embodiment, for instance, in order to reduce the pressure within the filter housing 22, a vacuum pump 34 is operated. As shown in FIG. 2, the vacuum pump 34 can be in communication with a valve 36 and a pressure gauge 38. In one embodiment, the valve 36 can comprise a 3-way valve that enables the vacuum pump to pull vacuum from the filter housing 12. In addition, the valve 36 can include a vent 42 for allowing gas pressures within the system to reduce and/or to increase back to atmospheric pressure or other desired pressure setpoint. The vent 42, for instance, can return the filter housing 12 back to atmospheric pressure after a cleaning cycle. For example, in one embodiment, the cleaning fluid can cycle between vacuum conditions and atmospheric conditions during cleaning of the membrane filters. In the embodiment illustrated, the vacuum pump 34 is in fluid communication with the flow control device 24. It should be understood, however, that the vacuum pump 34 can be placed in communication with the filter housing 22 at any suitable location.

In one embodiment, the valve 36 is opened and the vacuum pump 34 is activated which evacuates all air from the filter housing or cleaning chamber 22. Vacuum pump 34 can comprise any suitable pump capable of reducing the pressure within the filter housing 22 below the vapor pressure of the cleaning liquid. Pumps that may be used, for instance, include dry pumps, diaphragm pumps, liquid ring pumps, pneumatic pumps, a displacement pump, or the like. In one embodiment, the system can further include expansion space for expansion of gasses during operation of the vacuum pump 34. For instance, as shown in FIG. 2, an expansion chamber 40 can be placed in fluid communication with the vacuum pump 34 and the filter housing 22. The expansion chamber 40 may be needed, for instance, for the volume increase during gas expansion and to contain the gas collapse that occurs. The expansion chamber 40, in one embodiment, can be placed higher than the filter housing 22.

The vacuum pump 34 removes essentially all air from the filter housing 22 and also removes cleaning liquid vapor until an atmosphere in the filter housing 22 is at a pressure below the vapor pressure of the cleaning liquid contained in the filter housing. Once the pressure within the filter housing 22 is below the vapor pressure of the cleaning liquid, vapor bubbles begin to nucleate on the surface of the semipermeable membrane 12, such as on the surface of each of the filter elements 20 as shown in FIG. 3. In one embodiment, operation of the vacuum pump 34 continues which causes the formation of vapor bubbles to grow which creates violent disruptions at the surface of the membrane causing contaminants and impurities to detach from the membrane surface. For example, continual operation of the vacuum pump 34 causes further vapor to be removed from the filter housing 22 allowing for continual replenishment of cleaning liquid at the surface of the membrane which then undergoes bubble formation.

In one embodiment, the cleaning solution is expanded and contracted multiple times. In this manner, the filter membrane undergoes multiple cleaning cycles. The expansion chamber 40 facilitates the multiple cycles as the cleaning solution expands and contracts. After multiple cycles, in one embodiment, the filter housing 22 is flushed and returned to service. In the embodiment illustrated in FIG. 2, the flow control device 24 can be diverted to the expansion chamber 40 and vacuum pump 34 so that the filter housing 22 can be isolated while the effluent and reject streams are diverted.

The pressure achieved within the filter housing 22 during the process can vary depending upon the type of cleaning liquid that is used and the temperature of the cleaning liquid during the process. For example, in one embodiment, the pressure within the filter housing 22 is reduced below about 30 torr, such as less than about 25 torr, such as less than about 22 torr, such as less than about 20 torr, such as less than about 18 torr, such as less than about 16 torr, such as less than about 14 torr, such as less than about 12 torr. The pressure is generally greater than about 5 torr, such as greater than about 8 torr.

Phase one of the process during which the semipermeable membrane 12 is exposed to the cleaning liquid below its vapor pressure can last generally from about 30 seconds to about 30 minutes. In general, the first phase can occur for less than about 15 minutes, such as less than about 10 minutes.

Upon completion of the first phase, the vacuum pump 34 is turned off and valve 36 is opened in order to increase the pressure of the filter housing 22 to atmospheric pressure. For example, in one embodiment, the valve 36 and/or the valve 24 can serve as a divert valve to vent in order to break the vacuum and allow the vapor/liquid to collapse. In an alternative embodiment, however, a separate divert valve can be incorporated into the system. A pump or other similar device can then be used to circulate the cleaning liquid within the filter housing for rinsing the semipermeable membrane 12. The second phase of the cleaning cycle or the rinsing phase can then occur for a short period of time, such as less than about 10 minutes, such as less than about 5 minutes. The cleaning liquid can be drained from the filter housing 22 using the drain line 28 by opening the flow control device or valve 30. If desired, the entire process can be repeated in order to subject the semipermeable membrane 12 to multiple cleaning cycles. In an alternative embodiment, the cleaning solution can expand and contract multiple times to form multiple cleaning cycles. After multiple cleaning cycles, the filter membrane can be drained and rinsed once prior to being placed back into service.

The semipermeable membrane 12 for use in the process of the present disclosure, in one embodiment, can be selected such that the membrane can withstand the cleaning process and can withstand vacuum-like environments. When an ozonator 15 is present in the process as shown in FIG. 2, the semipermeable membrane 12 selected for use in the process should also be capable of not breaking down when contacted with an ozonated water feed. In this regard, in one embodiment, the filter membrane selected for use in the water purification process is a ceramic membrane. Ceramic membranes, for instance, are capable of being subject to multiple cleaning cycles without degrading. Ceramic filter membranes are also compatible with ozone and hot water. Also, of advantage, ceramic membranes are very efficient in filtering out organic components for lowering the total organic carbon present in the purified water stream.

Various different types of ceramic materials can be used to make ceramic membranes. Ceramic compounds can include, for instance, both metallic and non-metallic elements. In addition, in certain embodiments, the ceramic material can contain carbon. The different elements can be joined by ionic and/or covalent bonds. Examples of ceramic materials that can be used to produce ceramic membranes include metal oxides, metal carbides, nitrides, and/or carbonates. Specific materials can include silica, titania, alumina, titanium silicate, barium titanate, titanium carbide, titanium nitride, aluminum nitride, silicon carbide, and silicon nitride.

In order to form a ceramic membrane, in one embodiment, the ceramic material can be formed around a template. For example, in one embodiment, the template can be made from DNA stands.

Various different processes can be used to produce the membrane. For instance, the membranes can be formed using a sol-gel process. Alternatively, the membranes can be formed using dip coating or spin casting. In still another embodiment, DNA material can form a liquid crystal and can be encapsulated in a ceramic material while in a liquid crystalline state.

During formation of the ceramic membrane or after the membrane is formed, the surface of the ceramic material can also be modified or doped depending upon the particular application.

DNA molecules have been found to be particularly well suited for use as the template material in producing ceramic membranes. For instance, DNA molecules have the shape of a helix that makes them particularly well suited for forming pores. The DNA molecules can be oriented for use in a template using various different techniques, such as by using a magnetic or electric field.

Once the ceramic membrane is formed, the template material, such as the DNA, can be removed. The template materials, for instance, can be removed using any suitable method. In one embodiment, for instance, DNA molecules can be removed by calcining. For example, the ceramic membrane can be heated to high temperatures causing the DNA molecules to convert into gaseous species. In still another embodiment, solvents can be used to remove template materials. The solvents can include acids and super critical fluids.

After the template material is removed, the remaining ceramic membrane can be used as is or subjected to various different additional processes. In one embodiment, for instance, atomic layer deposition can be used in order to further reduce the diameter of the pores. The small diameter of the pores allows the separation of small molecules from one another based upon size and physical properties. The pore characteristics of the ceramic membrane, for instance, may allow only the passage of very small molecules making the membrane an ideal platform for water purification.

In one embodiment, the pores present in the ceramic membrane have a diameter of generally less than about 50 angstroms. The diameter of the pore as used herein is the smallest diameter of the pore if the pore is non-circular. In general, the diameter of the pores are less than about 30 angstroms, such as less than about 25 angstroms, such as less than about 20 angstroms, such as less than about 15 angstroms, such as less than about 10 angstroms, such as less than about 8 angstroms, such as less than about 6 angstroms, such as less than about 5 angstroms, such as less than about 4 angstroms. In general, the pore diameter is generally greater than about 0.1 angstroms, such as greater than about 0.5 angstroms. In one embodiment, the pore diameter is from about 1 angstrom to about 20 angstroms.

The ceramic membrane can have any suitable thickness necessary for purifying water. For instance, the ceramic membrane can have a thickness of generally less than about 500 microns, such as less than about 300 microns, such as less than about 100 microns. The thickness of the ceramic membrane is generally greater than about 10 microns.

In addition to ceramic membranes, it should be understood that any suitable membrane may be cleaned in accordance with the present disclosure. In one embodiment, for instance, the cleaning process may be operated such that the filter membranes contained in the system are not exposed to a pressure differential. For example, in one embodiment, opposite sides of the membrane can be exposed to a reduced pressure atmosphere simultaneously. In this manner, less durable membranes may be cleaned in accordance with the present disclosure.

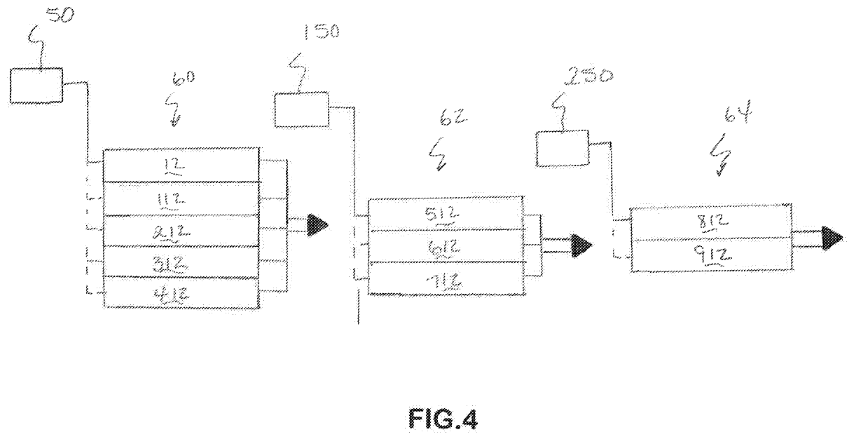

In one embodiment, the water purification system can include multiple banks of semipermeable membranes. For exemplary purposes only, FIG. 4, for instance, shows three banks of semipermeable membranes positioned in series. Feed water enters the first bank of membranes 60, is filtered, and is then forced through the second bank of membranes 62. From the second bank of membranes 62, the water is then forced through a third bank of membranes 64. In the embodiment illustrated in FIG. 4, the first bank of membranes includes a greater number of membranes than in the second bank and in the third bank. Similarly, the second bank 62 of membranes contains a greater number of membranes than the third bank 64 of membranes.

In accordance with the present disclosure, in one embodiment, each filter bank 60, 62 and 64 can be in communication with one or more cleaning subsystems that are designed to clean the semipermeable membranes contained within each bank. For example, as shown in FIG. 4, filter bank 60 is associated with a cleaning subsystem 50. The cleaning subsystem 50 can include a vacuum pump and a cleaning fluid supply. As shown in FIG. 4, the filter bank 60 includes a first semipermeable membrane 12, a second semipermeable membrane 112, a third semipermeable membrane 212, fourth semipermeable membrane 312, and a fifth semipermeable membrane 412. In one embodiment, the cleaning subsystem 50 can service each of the semipermeable membranes 12, 112, 212, 312, and 412. The cleaning subsystem 50 can be designed to clean one of the semipermeable membranes while the remaining semipermeable membranes remain in operation for purifying water. For instance, as shown in FIG. 4, the cleaning subsystem 50 can be used to clean the semipermeable membrane 12 while the remaining semipermeable membranes 112, 212, 312, and 412, can remain in operation. The cleaning subsystem 50 can then be designed to move from filter membrane to filter membrane within the bank 60 for periodically cleaning each membrane.

Similarly, filter bank 62 is shown in association with a cleaning subsystem 150. The cleaning subsystem 150 is designed to clean the semipermeable membrane filters 512, 612, and 712 one at a time while the remaining membrane filters remain in operation. Filter bank 64 includes semipermeable membranes 812 and 912 which can be cleaned by a cleaning subsystem 250.

As described above, the cleaning system and process of the present disclosure can be used to periodically clean the membranes contained in the water purification system for maintaining efficiency. The length of time between each cleaning cycle can vary depending upon many different factors and parameters. In one embodiment, the semipermeable membranes contained in the water purification system can be cleaned after a certain period of time. In an alternative embodiment, various process conditions can be monitored which may indicate the need to clean the filter membranes. For example, in one embodiment, the semipermeable membranes may be cleaned depending upon the amount of reject water that is produced during operation of the water purification system. For example, in one embodiment, the semipermeable membranes may be cleaned after the reject water stream is greater than about 10% of the feed water stream, such as greater than about 20%, such as greater than about 25%, such as greater than about 30%, such as greater than about 35% of the feed water stream. In one particular embodiment, the system and process of the present disclosure are operated such that the reject water stream never rises about 25% of the feed water stream by volume.

In an alternative embodiment, a downstream parameter can be measured to determine whether the semipermeable membranes need cleaning. In one embodiment, for instance, total organic carbon can be measured downstream in the purified water stream. Once the total organic carbon rises above a certain level, an indicator or controls may be put into place such that the semipermeable membrane filters are cleaned.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A method for purifying water comprising:
forcing a flow of water through at least one filter bank to form a purified water stream and a reject water stream, the filter bank comprising at least one membrane; and
periodically cleaning the membrane in-line, the membrane being cleaned by subjecting the membrane to a liquid in an atmosphere that is below a vapor pressure of the liquid.

2. A method as defined in claim 1, wherein the at least one membrane comprises a ceramic membrane.

3. A method as defined in claim 1, wherein the flow of water is purified through reverse osmosis by being forced through the at least one filter bank.

4. A method as defined in claim 1, wherein, during cleaning, the membrane is submersed in the liquid and wherein the pressure of the atmosphere surrounding the membrane is lowered below the vapor pressure of the liquid by evacuating gases from the atmosphere.

5. A method as defined in claim 4, wherein a surface of the membrane creates nucleation sites for bubble formation of the liquid when the pressure is lowered.

6. A method as defined in claim 1, wherein the liquid used during cleaning comprises water.

7. A method as defined in claim 6, wherein the liquid used during cleaning comprises water combined with a non-aqueous solvent.

8. A method as defined in claim 1, wherein the ceramic membrane is contained in a filter housing and wherein, during periodic cleaning, the filter housing is converted into a cleaning chamber for maintaining the atmosphere surrounding the ceramic membrane at a pressure below the vapor pressure of the liquid.

9. A method as defined in claim 1, wherein the at least one filter bank includes a plurality of membranes and wherein, during cleaning, at least one of the membranes is cleaned while at least certain other membranes continue to receive the flow of water for purifying the water.

10. A method as defined in claim 1, wherein the flow of water is forced through from about two to about five filter banks, the filter banks being placed in series.

11. A method as defined in claim 1, wherein the method further comprises the step of ozonating a feed water source to produce the flow of water that is forced through the at least one filter bank, the ozonated water having a total organic carbon content and wherein the membrane filters organic components from the flow of water for lowering the total organic carbon content in the flow of water.

12. A method as defined in claim 1, wherein the atmosphere surrounding the membrane that is below the vapor pressure of the liquid is at a pressure of from about 30 torr to about 1 torr.

13. A method as defined in claim 1, wherein after the membrane is subjected to the liquid during cleaning at an atmosphere below the vapor pressure of the liquid, the membrane is rinsed with the liquid at a pressure above its vapor pressure.

14. A method as defined in claim 1, wherein each periodic cleaning of the membrane includes multiple cycles of subjecting the membrane to the liquid below its vapor pressure and above its vapor pressure such that the liquid expands and contracts multiple times.

15. A method as defined in claim 1, wherein the membrane has a pore size of less than 1 nm.

16. A method as defined in claim 1, wherein the liquid is heated to a temperature of at least 30° C.

17. A reverse osmosis system comprising;
at least one filter bank comprising at least one ceramic membrane contained in a filter housing;
a pump for forcing a flow of water through the filter bank in order to produce a purified water stream and a reject water stream; and
a cleaning subsystem for the at least one ceramic membrane comprising:
(a) a vacuum pump;
(b) a capping device for converting the filter housing into a cleaning chamber during cleaning of the ceramic membrane; and
(c) a cleaning fluid supply in fluid communication with the filter housing and, wherein the cleaning subsystem is configured to periodically clean the ceramic membrane by converting the filter housing into a cleaning chamber, flowing a cleaning fluid into the cleaning chamber, and evacuating gases from the cleaning chamber using the vacuum pump until an atmosphere in the chamber is below a vapor pressure of the cleaning liquid.

18. A system as defined in claim 17, wherein the capping device comprises a valve device.

19. A system as defined in claim 17, wherein the system includes multiple filter banks positioned in series, each filter bank including a cleaning subsystem.

20. A system as defined in claim 17, wherein the ceramic membrane has a pore size of less than 1 nm.

21. A system as defined in claim 17, wherein the ceramic membrane comprises a DNA templated ceramic membrane.

22. A system as defined in claim 17, further comprising an ozonator for ozonating a feedwater prior to forcing the flow of water through the filter bank.
